(19) United States
(12) Patent Application Publication
(10) Pub. No.: US 2005/0022490 A1
(43) Pub. Date: Feb. 3, 2005

(54) Vehicle air cleaner

(76) Inventors: Ruey-Fa Huang, Sioushuei Township (TW); Tsung-Min Huang, Sioushuei Township (TW)

Correspondence Address: TROXELL LAW OFFICES PLLC, SUITE 1404, 5205 LEESBURG PIKE, FALLS CHURCH, VA, 22041, US

(21) Appl. No.: 10/629,716

(22) Filed: Jul. 30, 2003

(51) Int. Cl. B01D 46/00

(52) U.S. Cl. 55/486; 55/497; 55/502

(57) ABSTRACT

A vehicle air cleaner includes a filter material and a frame, which is formed integral around the circumferential edge of the filter material. The filter material is curved into a plurality of V-shaped air intake grooves able to let air filtered and sucked into an engine quickly and effectively. The frame has its upper edge formed with an arc-shaped current guiding surface able to smoothly guide air to move downward into the air intake grooves. The vehicle air cleaner of the invention is able to filter air effectively, avoid clogging of the filter material, and increase quantity of air sucked into the engine for carrying out complete combustion so as to lower exhaust and maintain good air quality.

### BACKGROUND OF THE INVENTION

1. Field of the Invention

This invention relates to a vehicle air cleaner, particularly to one able to filter air effectively and increase quantity of air sucked into an engine for use.

2. Description of the Prior Art

The air cleaner of an automobile or a motorcycle is generally installed in the air chamber positioned between the air intake manifold and the engine for filtering impurities in air so as to supply the engine with the filtered air for the engine to carry out combustion. A conventional air cleaner 10, as shown in FIGS. 1 and 2, is provided with a filter material 11 having its circumferential edge wrapped up by a frame 12. The filter material 11 includes an inner layer made of non-woven fabric 111 and an outer layer wrapped by metallic gauze 112. The filter material 11 is continuously curved into a plurality of upward and downward U-shaped grooves spaced apart equidistantly and formed with plural arc-shaped curved portions 113 at the upper and the lower side. Between every two curved portions 113 is formed an air intake groove 114 and having its opposite filter-material walls 115 positioned in parallel. Although the conventional air cleaner 10 has effect of air filtering, it has the following drawbacks in structure.

1. Referring to FIG. 2, when the engine of a vehicle operates, air will be sucked into the air chamber and, after filtered by the filter material 11 of the air cleaner 10, it will get into the engine for us e. Since the air intake groove 114 are parallel to one another; the refore, when air is sucked into the air chamber, its flowing direction is parallel to the opposite filter-material walls 115 of the air intake groove 114. Under such circumstances, most of the air will pass through and be filtered by the curved portions 113 of the air intake grooves 114, with only a little of the air passing through the filter-material walls 115 of the air intake grooves 114, that is, only a small part of the filter material 11 function to carry out air cleaning. Besides, as air filtering is carried out mostly by the curved portions 113 of the air intake grooves 114, the curved portions 113 are likely to cause clogging, thus failing to supply the engine with sufficient air for carrying out combustion.

2. Air filtering is excess iv ely concentrated on the curved portions 113 of the air intake grooves 114, therefore the curved portions 113 may be stuck with sediment of air impurities and be clogged in a short period of time, accordingly lowering the quantity of air sucked into the engine.

3. The upper edge 121 of the frame 12 is a plane surface; therefore, when air is sucked into the air chamber and directly touches the upper edge 121, it will be trued back or flow along two sides of the upper edge 121, resulting in reactive and obstructive current of air and deteriorating air flow into the engine.

### SUMMARY OF THE INVENTION

The objective of the invention is to offer a vehicle air cleaner having its filter material continuously curved into a plurality of V-shaped air intake grooves respectively having a wide opening and narrow curved portion so that air can effectively and quickly be filtered and sucked into the engine for use, able to increase the quantity of air sucked into the engine for carrying out complete combustion.

### BRIEF DESCRIPTION OF DRAWINGS

This invention will be better understood by referring to the accompanying drawings, wherein:

FIG. 1 is a perspective view of a conventional air cleaner:

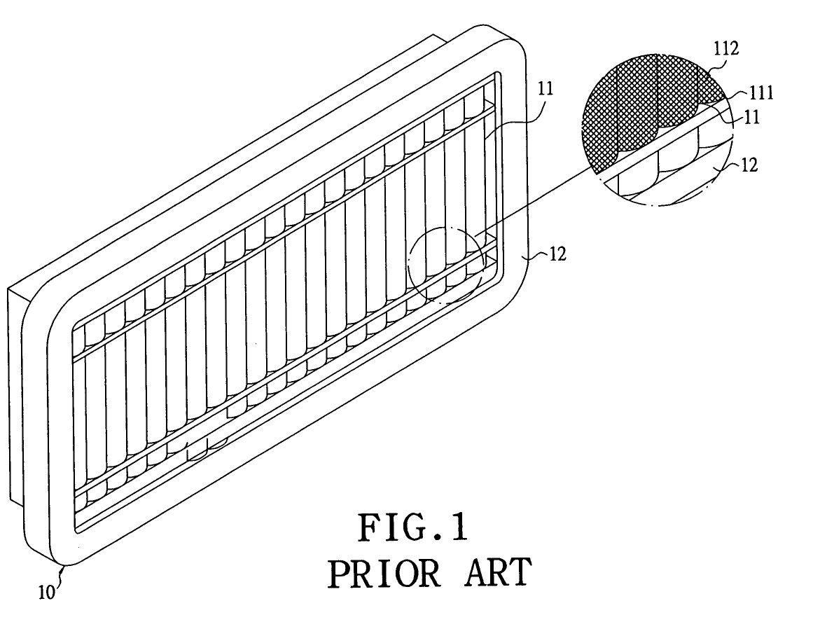

FIG. 2 is a partial cross-sectional view of the conventional vehicle air cleaner, showing the flowing directions of air:

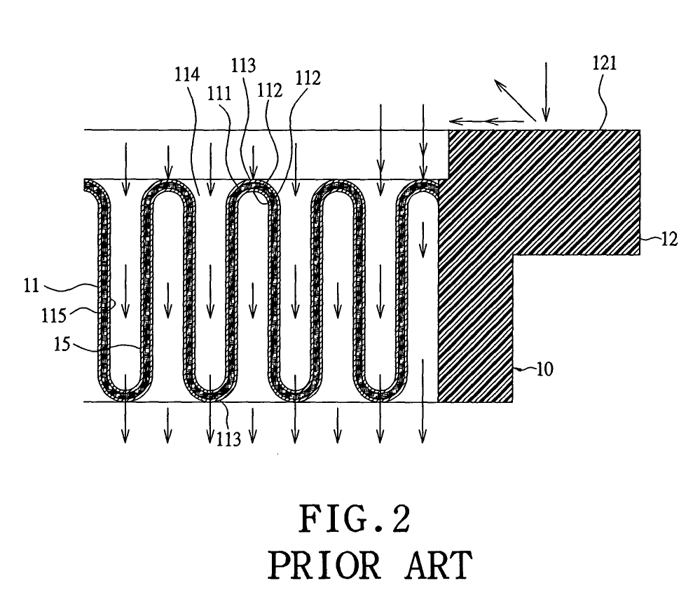

FIG. 3 is a perspective view of a first preferred embodiment of a vehicle air cleaner in the present invention:

FIG. 4 is a partial cross-sectional view of the first preferred embodiment of the vehicle air cleaner in the present invention:

FIG. 5 is a cross-sectional view of the first preferred embodiment of the vehicle air cleaner in the present invention, showing the flowing directions of air: and

FIG. 6 is a partial cross-sectional view of a second preferred embodiment of a vehicle air cleaner in the present invention.

### DETAILED DESCRIPTION OF THE PREFERRED EMBODIMENT

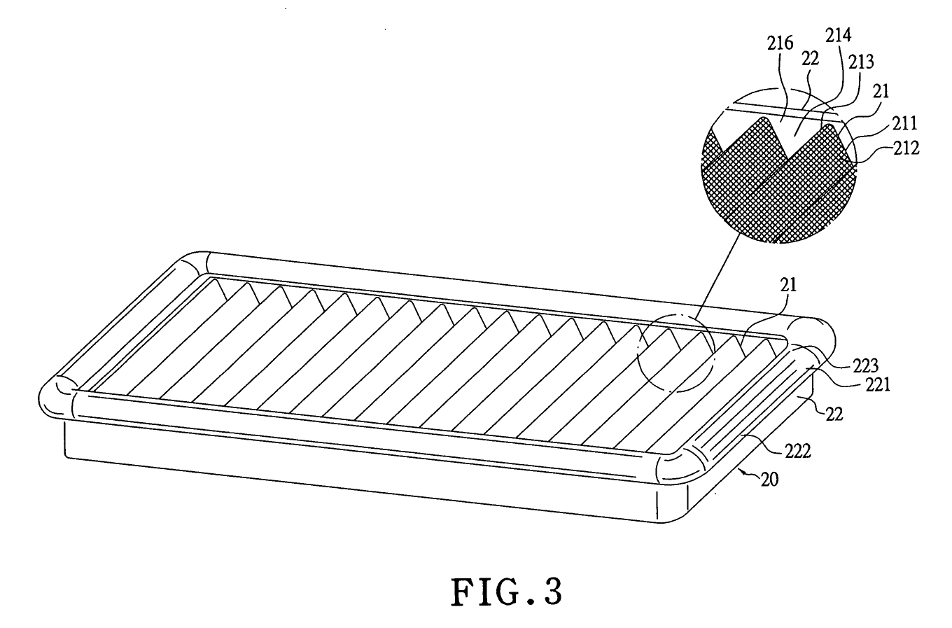

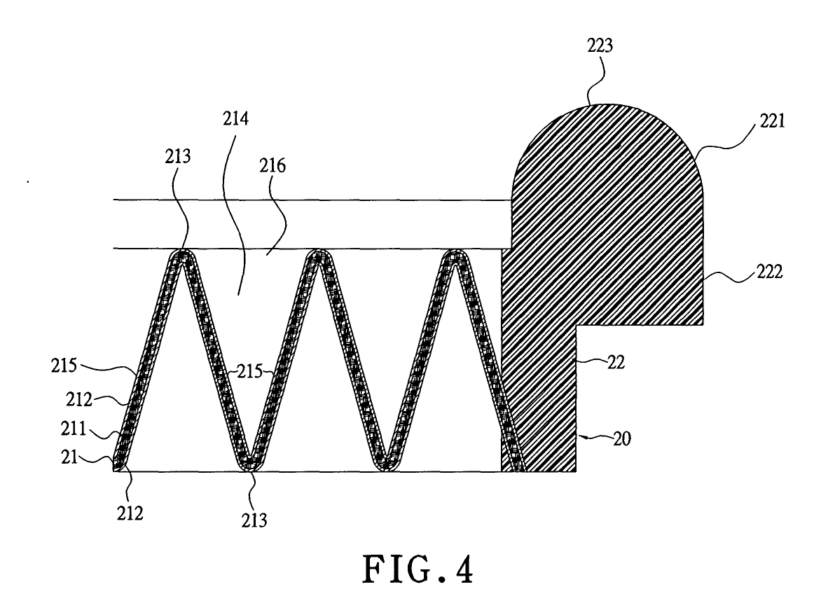

A first preferred embodiment of a vehicle air cleaner in the present invention, as shown in FIGS. 3 and 4, includes a filter material 21 and a frame 22, which is formed integral around the circumferential edge of the filter material 21.

The filter material 21 is composed of a filter cloth 211 and metallic gauze 212. The filter cloth 211 is non-woven fabric able to filter impurities in air, while the metallic gauze 212 wraps and clamps the upper and the lower surface of the filter cloth 211 so as to make up a strengthened and permeable filter structure. The filter material 21 is a corrugated structure curving up down continuously and forming a plurality of curved portions 213 respectively at the upper and the lower side. Between every two curved portions 213 are formed a V-shaped air intake groove 214 and having its opposite filter-material walls 215 forming a wide opening 216 and a narrow curved portion 213.

The frame 22 shaped a rectangle is made of a flexible and compressible material, such as rubber and the like. The filter material 21 has its circumferential edge completely surrounded by the frame 22. The upper edge 221 of the frame 22 has its outer lower edge formed with a straight surface 222, which then extends upward and inward for a preset curve and forms a current guiding surface 223.

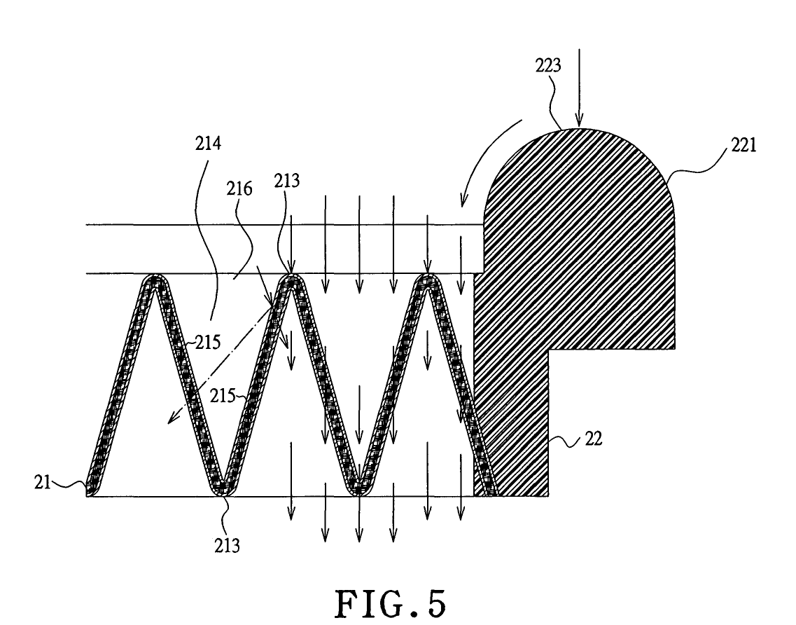

The air cleaner 20 of the present invention is installed in the air chamber of a vehicle for use. Air will be sucked into the air chamber when the engine of the vehicle operates. Since each V-shaped air intake groove 214 is formed with a wide opening 216 and a narrow curved portion 213, and its opposite the filter-material walls 215 extend upward and outward obliquely. Therefore, when air is sucked into the air chamber in straight directions, the air will directly pass through both the curved portions 213 and the filter-material walls 215 of the air intake grooves 214. Thus, the air will pass through every part of the filter material 21 and then be sucked in the engine for use, as shown in FIG. 5, able to achieve excellent effect in air filtering, preventing air impurities from precipitating or clogging at a certain part of the filter material 21 and increasing quantity of air sucked into the engine for use.

In addition, the air intake grooves 214 are V-shaped; therefore, even though air sucked into the air chamber moves to the filter-material walls 215 in irregular and oblique directions, most of the air will directly pass through the filter material 21, with a small amount of it reflected downward to the abutting filter-material wall 215 and pass therethrough, able to filter air quickly and increase quantity of air to be sucked into the engine to elevate its operating efficiency.

Further, the frame 22 has its upper edge 221 formed with an arc-shaped current guiding surface 223; therefore, when air is sucked into the air chamber and directly touches the upper edge 221, the air can be smoothly guided by the current guiding surface 223 to move downward into the air intake grooves 214 and pass through the filter material 21 and be filtered, impossible to produce reflected current of air or reactive and obstructive air flow, increasing quantity of air sucked into the engine for us e.

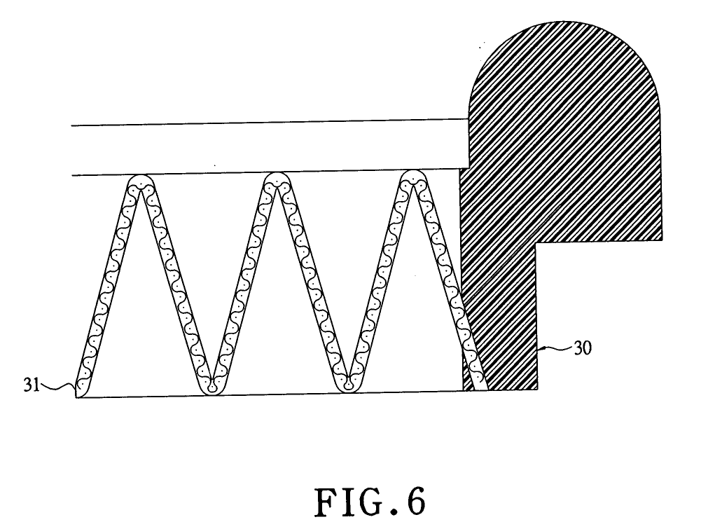

A second preferred embodiment of a vehicle air cleaner in the present invention, as shown in FIG. 6, is provided with a filter material 31, which is metallic gauze made of stainless steel. Such a filter material 31 can not only filter air effectively but also has a great strength and can be cleaned easily and used repeatedly.

Specifically, the vehicle air cleaner of this invention has its filter material curved into a plurality of V-shaped air intake grooves to enable air to pass through all parts of the filter material and be filtered. Besides, the arc-shaped current guiding surface on the upper edge of the frame is able to smoothly guide air to move into the air intake grooves to be filtered. To sum up, the specially-designed vehicle air cleaner of this invention can filter air effectively, able to avoid clogging of the filter material and increase quantity of air sucked into the engine for carrying out complete combustion to lower exhaust and maintain good air quality.

While the preferred embodiments of the invention have been described above, it will be recognized and understood that various modifications may be made therein and the appended claims are intended to cover all such modifications that may fall within the spirit and scope of the invention.

1. A vehicle air cleaner comprising a filter material and a frame, said frame formed integral around the circumferential edge of said filter material:
Said filter material being a permeable gauze of a preset strength, said filter material able to filter impurities in air, said filter material curved up and down continuously and formed with a corrugated structure, between every two curved portions formed a v-shaped air intake groove, each said air intake groove having its opposite filter-material walls and forming a wide opening and a narrow curved portion, said v-shaped air intake grooves enabling air quickly filtered and sucked into the engine for use, increasing quantity of air sucked into the engine for carrying out combustion: and
Said frame made of a compressible and flexible material, an upper side of said frame having its outer lower edge formed with a straight vertical surface, said straight vertical surface extending upward and inward to form a current guiding surface of a preset curve.

2. The vehicle air cleaner as claimed in claim 1, wherein said frame is shaped a rectangle made integral of rubber, and said filter material has its circumferential edge completely surrounded by said frame.

3. The vehicle air cleaner as claimed in claim 1 or 2, wherein said filter material is composed of a filter cloth and a metallic gauze and said filter cloth is non-woven fabric able to filter air, said metallic gauze wrapping and clamping the surfaces of said filter cloth to strengthen the structure of said filter material.

4. The vehicle air cleaner as claimed in claim 3, wherein said filter cloth is cotton cloth.

5. The vehicle air cleaner as claimed in claim 1 or 2, wherein said filter material is a metal gauze made of stainless steel, having a strengthened structure and able to be cleaned easily and employed repeatedly.
